(19) United States
(12) Patent Application Publication
(10) Pub. No.: US 2026/0334495 A1
(43) Pub. Date: Oct. 29, 2026

(54) FLAVOR CHEESE PRODUCTS, FOOD PRODUCTS CONTAINING SUCH FLAVOR CHEESE PRODUCTS AND SYSTEMS AND METHODS OF MAKING SAME

(71) Applicant: Land O'Lakes, Inc., Arden Hills, MN (US)

(72) Inventors: Thomas Alexander Glenn, III, Arden Hills, MN (US); Cara Nelson, Arden Hills, MN (US); Emily Leuer, Arden Hills, MN (US); Alexandra Metelak, Arden Hills, MN (US); Sean Larson, Arden Hills, MN (US)

(21) Appl. No.: 19/698,709

(22) Filed: Jun. 4, 2026

Related U.S. Application Data
(63) Continuation of application No. PCT/US2024/057779, filed on Nov. 27, 2024.
(60) Provisional application No. 63/608,951, filed on Dec. 12, 2023.
(60) Provisional application No. 63/608,961, filed on Dec. 12, 2023.
(60) Provisional application No. 63/608,971, filed on Dec. 12, 2023.
(60) Provisional application No. 63/608,985, filed on Dec. 12, 2023.
(60) Provisional application No. 63/609,004, filed on Dec. 12, 2023.
(60) Provisional application No. 63/609,024, filed on Dec. 12, 2023.
(60) Provisional application No. 63/665,388, filed on Jun. 28, 2024.

(51) Int. Cl. A23C 19/032; A23C 9/142; A23C 19/04

(52) U.S. Cl. CPC A23C 19/0328; A23C 9/1422; A23C 19/043; A23C 2210/202

(57) ABSTRACT

Methods of producing flavor cheese products involve adding an adjusted milk composition to a fermentation tank having least one of a reduced protein-to-fat ratio or a reduced lactose-to-fat ratio relative to a starting milk composition; fermenting the adjusted milk composition in the fermentation tank to cause in situ production of lactic acid, where the adjusted milk composition is free of rennet; transferring the fermented adjusted milk composition; adding a lipase, a protease or both to the composition having a temperature of about 60 °F to 98 °F; evaporating water therefrom at a temperature of about 80 °F to 120 °F to form a cheese composition; and curing the cheese composition for a curing period of about 3 to 6 weeks at a temperature between about 38 °F to 75 °F. Enzymatic activity of the added lipase, protease or both is maintained through the curing period to form the flavor cheese product.

### CROSS-REFERENCE TO RELATED APPLICATIONS

This application is a continuation of International Application No. PCT/US2024/057779, filed on Nov. 27, 2024, entitled “FLAVOR CHEESE PRODUCTS, FOOD PRODUCTS CONTAINING SUCH FLAVOR CHEESE PRODUCTS AND SYSTEMS AND METHODS OF MAKING SAME”, which in turn claims priority to U.S. Provisional Patent Application No. 63/608,951, filed Dec. 12, 2023, entitled “FOOD PRODUCTS AND SYSTEMS AND METHODS OF MAKING SAME,” and U.S. Provisional Patent Application No. 63/608,961, filed Dec. 12, 2023, entitled “FOOD PRODUCTS AND SYSTEMS AND METHODS OF MAKING SAME”, and U.S. Provisional Patent Application No. 63/608,971, filed Dec. 12, 2023, entitled “FOOD PRODUCTS AND SYSTEMS AND METHODS OF MAKING SAME”, and U.S. Provisional Patent Application No. 63/608,985, filed Dec. 12, 2023, entitled “FOOD PRODUCTS AND SYSTEMS AND METHODS OF MAKING SAME”, and U.S. Provisional Patent Application No. 63/609,004, filed Dec. 12, 2023, entitled “FOOD PRODUCTS AND SYSTEMS AND METHODS OF MAKING SAME”, and U.S. Provisional Patent Application No. 63/609,024, filed Dec. 12, 2023, entitled “FOOD PRODUCTS AND SYSTEMS AND METHODS OF MAKING SAME”, and U.S. Provisional Patent Application No. 63/665,388, filed Jun. 28, 2024, entitled “FLAVOR CHEESE PRODUCTS, FOOD PRODUCTS CONTAINING SUCH FLAVOR CHEESE PRODUCTS AND SYSTEMS AND METHODS OF MAKING SAME”, each of which is incorporated by reference herein, in the entirety and for all purposes.

### TECHNICAL FIELD

Dairy products and systems and methods for production of such dairy products are disclosed.

### BACKGROUND

Bacterial fermentation of lactose in a dairy-derived starting material produces lactic acid and an attendant decrease in pH. Ingredients such as preservatives and emulsifiers are typically added to dairy products to maintain the desired characteristics, including desired flavor, aroma, appearance, consistency, texture, and/or meltability, of dairy products throughout their shelf life.

Dairy product producers continue to seek improved methods of production. Consumers continue to seek dairy products with fewer, and fewer artificial, added ingredients.

### SUMMARY

The present disclosure relates to flavor cheese products and methods and systems for producing the same.

In some aspects, a method of producing a flavor cheese product may include adding an adjusted milk composition to a fermentation tank. The adjusted milk composition may contain at least one of a reduced protein-to-fat ratio or a reduced lactose-to-fat ratio relative to a starting composition of milk. The method may include fermenting the adjusted milk composition in the fermentation tank to cause in situ production of lactic acid, wherein during the fermenting the adjusted milk composition may be free of rennet. The method may further include transferring the fermented adjusted milk composition from the fermentation tank and adding a lipase, a protease or both to the transferred fermented adjusted milk composition having a temperature of about 60 °F to about 98 °F. The method may include evaporating at least a portion of water therefrom at a temperature of about 80 °F to about 120 °F to form a cheese composition. The method may also include curing the cheese composition for a curing period at a temperature between about 38 °F to about 75 °F, wherein the curing period may be about 3 to 6 weeks. Enzymatic activity of the added lipase, protease or both may be maintained through the curing period to form the flavor cheese product.

In some aspects, the adjusted milk composition may be a microfiltration concentrate or an ultrafiltration concentrate having the reduced protein-to-fat ratio. The adjusted milk composition may be fermented by a cheese culture. In some cases, the method may further include adding rennet during the adding of the lipase, the protease or both. The flavor cheese product may have an acid degree value (ADV) of at least 8 and may contain at least about 2.0 wt % non-protein nitrogen (NPN).

In some aspects, a fermented flavor cheese product may include an admixture of a cured enzyme-modified fermentation base, one or more active dairy cultures, one or more active lipases, active proteases or both, and a total solids content of at least 60 wt %. The one or more active lipases, proteases or both may be retained in the fermented flavor cheese product. The fermented flavor cheese product may have been fermented without rennet and may have been cured for about 3 to 6 weeks. In some cases, a fat content may be about 30 wt % to about 33 wt % of the product, and protein may be about 18 wt % to about 22 wt % of the product.

In some aspects, a system for producing a flavor cheese product may include a fermenter for causing in situ production of lactic acid in an adjusted milk composition to produce a fermentation base, wherein the fermentation base may be free of rennet. The system may include at least one pump arranged downstream of the fermenter, each of the at least one pump for pumping a lipase or a protease into the fermentation base after exiting the fermenter. The system may further include an evaporator arranged downstream of the fermenter for evaporating at least a portion of water therefrom at a temperature of about 80 °F up to about 120 °F to form a cheese composition. The system may also include a curing environment for curing the cheese composition for a curing period of about 3 to 6 weeks at a temperature between about 38 °F to about 75 °F. Enzymatic activity of the lipase, the protease or both may be maintained through the curing period to form the flavor cheese product.

In addition, production of flavor cheese products may, according to certain implementations, involve adding an adjusted milk composition to a fermentation tank in which the adjusted milk composition contains at least one of a reduced protein-to-fat ratio or a reduced lactose-to-fat ratio relative to a starting composition of milk. The adjusted milk composition may then be fermented in the fermentation tank to cause in situ production of lactic acid. The fermented adjusted milk composition is transferred from the fermentation tank and a lipase, a protease or both are added to the transferred fermented adjusted milk composition having a temperature of about 60 °F to about 98 °F. At least a portion of water is evaporated therefrom at a temperature of about 60 °F to about 120 °F to form a cheese composition. The cheese composition is cured for a curing period at a temperature between about 38 °F to about 75 °F, where enzymatic activity of the added lipase, protease or both is maintained through the curing period to form the flavor cheese product.

In various implementations and alternatives: the curing period may be about 1 to 6 weeks, such as about 3 to 4 weeks; and/or an acid degree value (ADV) of the flavor cheese product may be at least 8; and/or at least about 2.0 wt % non-protein nitrogen (NPN) may be present in the flavor cheese product.

In various implementations and alternatives, rennet may be added during the adding of the lipase, protease or both; and in such case the lipase may be added to the transferred fermented adjusted milk composition, and the lipase added separately from the added rennet, and separately from the protease, when present.

The adjusted milk composition may be a microfiltration concentrate or may be an ultrafiltration concentrate having the reduced protein-to-fat ratio, may be fermented by a cheese culture, and/or may be maintained at a temperature below about 98 °F during the fermenting and the transferring.

The cheese composition may include about 60 to about 70 wt % solids.

In various implementations and alternatives, the method may further involve heating the adjusted milk composition prior to transferring, where the heating is to at least 165 °F.

In some cases, the cured cheese product is held at refrigeration temperatures.

Prior to fermenting, the adjusted milk composition may be heat treated to a temperature of about 155 °F to about 175 °F and then cooled to a temperature of about 110 °F or about 86 °F.

According to further implementations, a fermented flavor cheese product may include an admixture of a cured enzyme-modified fermentation base, one or more active dairy cultures, one or more active lipases, proteases or both, and a total solids content of at least 60 wt %, the one or more active lipases, proteases or both retained in the fermented flavor cheese product.

In some cases, the one or more active dairy cultures may be retained in the fermented flavor cheese product; a fat content is about 30 wt % to about 33 wt % of the product, and protein is about 18 wt % to about 22 wt % of the product; and/or an acid degree value (ADV) of the product may be least 10, and/or the product may contain at least about 2.0 wt % non-protein nitrogen (NPN).

According to still further implementations, a system for producing a flavor cheese product may include: a fermenter for causing in situ production of lactic acid in an adjusted milk composition to produce a fermentation base; at least one pump arranged downstream of the fermenter, each of the at least one pump for pumping a lipase or a protease into the fermentation base after exiting the fermenter; an evaporator arranged downstream of the fermenter for evaporating at least a portion of water from therefrom at a temperature below 120 °F to form a cheese composition; and a curing environment for curing the cheese composition for a curing period at a temperature between about 38 °F to about 75 °F, where enzymatic activity of the lipase, protease or both is maintained through the curing period to form the flavor cheese product.

The system may additionally include balance tank arranged downstream of the fermenter and upstream of the evaporator, where the balance tank receives the pumped lipase, the pumped protease or both and the fermentation base.

### BRIEF DESCRIPTION OF THE DRAWINGS

FIGS. 1A-1C are schematics of methods and systems used in connection with making flavor cheese products, according to embodiments disclosed herein.

FIG. 2 is a schematic of a method of using flavor cheese products to produce final food products.

### DETAILED DESCRIPTION

Implementations are directed to methods of producing flavor cheese products and food products containing such flavor cheese products. Flavor cheese products may include but not limited to dairy products having the standard identity of cheese, such as the standard identity of cheddar cheese, Asiago, brick, Blue, Colby, Gouda/Edam, Monterey Jack, Parmesan, Swiss, pepper jack, mozzarella, Muenster, cotija, and/or Romano, enzyme modified cheese, accelerated ripened cheese, and cheese (e.g., natural cheese). Flavor cheese products may be an intensely flavored standard of identity cheese for use in food manufacture to deliver high intensity cheese flavor as a food ingredient. The flavor cheese products contain high levels of exogenous enzymes, e.g., lipases and proteases, thus providing an increased free fatty acid content, e.g., with an increased acid degree value (ADV), as well as a changed proportion of protein, e.g., the proportion of intact protein as a percent of non-protein nitrogen (NPN) is increased with a proportional decrease in casein, compared to traditional cheese. Food products containing the presently disclosed flavor cheese products may include blends of dairy products, such as cheese blend products including those with process cheese, ingredient cheese, cheese sauces, heat-treated cheese sauces, pasteurized cheese sauces, process cheese, pasteurized process cheese, dairy spreads, pasteurized process cheese spreads, pasteurized process cheese products (e.g., process cheese loaf and process cheese spread products), pasteurized process cheese food, pasteurized process cheese product or pasteurized blended cheese, and precursors or intermediates to production of any of the foregoing.

Milk compositions used in producing the flavor cheese products of the present disclosure may include liquid whole milk, reduced fat milk, skim milk, cream, ultrafiltered milk, microfiltered milk, buttermilk, condensed skim milk, condensed whole milk, condensed buttermilk, or mixtures thereof, in liquid or dried forms and rehydrated mixtures thereof. Additionally or alternatively the milk be pasteurized. Additionally or alternatively the milk be concentrated liquid milk. Any disclosed dairy product may exclude one or more of the foregoing milk forms. For example, a disclosed dairy product may be free of skim milk.

The milk compositions may be pasteurized and/or standardized. Pasteurization of milk involves heating the milk at temperatures and holding times that destroy pathogens, such as Listeria and Salmonella, present in raw milk. For example, pasteurization may be conducted at 145 °F for 30 minutes or 161 °F for 15 seconds. Pasteurization may be performed prior to further adjustment or processing, as described herein. Standardization of milk may involve the addition of cream to reach a target fat-to-protein ratio. In some examples, a blend of milk (e.g., raw milk) and cream and/or skim milk result in a raw standardized milk with a desired fat-to-protein ratio, for instance based on standard identity requirements of the dairy product(s) being produced, along with texture, melt and application characteristics/considerations of a final dairy product being produced. Standardized milk may be pasteurized at high temperature short time (HTST) conditions (e.g., at a temperature of greater than or equal to 161 °F for 15 seconds) and cooled to approximately 130 °F (e.g., 126 °F+/−4 °F) before further processing of the milk composition, as described herein.

### Adjustment of Milk Compositions

The starting milk compositions disclosed herein may be subjected to a milk composition adjustment process, such as by removing at least a portion of one or more milk components. For example, protein, protein-containing components (e.g., whey and casein), fat, lactose, minerals, solids nonfat, water, or combinations thereof, may be removed from the milk composition. Adjustment processes to produce adjusted milk compositions may include but are not limited to microfiltration, ion exchange, centrifugation, vat processing, enzyme treatment, ultrafiltration, reverse osmosis, nanofiltration, evaporation, and addition of dairy components each as described in more detail herein. Prior to adjustment, the starting milk composition may be unsalted or salted.

The milk composition adjustment processes may remove at least a portion of the aforementioned milk components while retaining others. For example, removal of at least a portion of one or more milk components from the milk composition, e.g., the starting milk composition, may prepare a dairy stream for subsequent processing steps in which retention of the remaining milk components is desired through the production process. In some cases, the remaining milk components may be retained in an intermediate product, or both in the intermediate and a final product. In some embodiments, the adjustment process may remove at least a portion of whey protein and/or lactose from the milk compositions. For instance, the adjusted milk composition may have both a reduced protein-to-fat ratio and a reduced lactose-to-fat ratio relative to a starting milk composition. As disclosed herein, removal of at least a portion of the whey protein may help produce final products with improved properties compared to final products that retain more whey proteins. For instance, removal of whey protein may facilitate avoiding negative impacts during processing and may improve product performance characteristics (e.g., undesirable flavors, texture and melting characteristics). Removal of whey protein while retaining fat may prepare the dairy stream for production of dairy products with an adjusted ratio, e.g., a reduced protein-to-fat ratio or a higher fat-to-protein ratio. Removal of at least a portion of lactose from the milk compositions may prepare the dairy stream for further processing steps, as disclosed herein. Lactose reduction may facilitate controlling the amount of lactic acid and/or final pH during subsequent processing, such as fermentation, as provided herein. Removal of lactose while retaining fat may also prepare the dairy stream for production of dairy products with an adjusted nutrient ratio, e.g., a reduced lactose-to-fat ratio or a higher fat-to-lactose ratio. Removal of at least a portion of fat from the milk compositions may prepare the dairy stream for production of dairy products with an adjusted, e.g., a higher, protein-to-fat ratio. Removal of at least a portion of the water from the milk compositions such as through evaporation, microfiltration or ultrafiltration may prepare the milk stream for further processing, as disclosed herein.

### Microfiltration

Microfiltration of milk results in removal of whey protein (e.g., serum protein), lactose, water, and minerals. For example, microfiltration of whole milk results in retention of native milk fat globules along with other milk components while removing at least a portion of the whey, lactose, and minerals via the permeate stream, which may provide improved dairy products as disclosed herein. Adjusting the milk composition via microfiltration may additionally involve one or more diafiltration steps based on the desired level of extraction of the serum or whey protein and lactose. For example, water may be added to the microfiltered retentate before subsequent filtration to further reduce the concentration of lactose and minerals. The number of diafiltration steps may depend on the desired properties of the microfiltration retentate and the final product. The adjusted milk composition may thus be the retentate of the microfiltration and optional diafiltration steps and may include fat, and a portion of the initial protein, lactose, mineral, and moisture content from the milk. The milk may be non-acidified or acidified prior to filtration, such as by the addition of edible acids or enzymes such as citric acid, acetic acid, lactic acid, protease, carbon dioxide, or lipase. Acidification of milk prior to microfiltration may result in an increased amount of calcium being transferred to the permeate. Microfiltration may be conducted at about 120 °F to about 140 °F, such as about 125 °F to about 135 °F.

In some implementations, a starting milk composition such as pasteurized and standardized milk may be subjected to a microfiltration process that includes diafiltration water addition, where a portion of the lactose and whey are removed. Concentration through microfiltration may concentrate by approximately 5.5 times, or a volume reduction to approximately 18.2% of its initial volume. Diafiltration in combination with microfiltration may further reduce the lactose and whey protein below what would otherwise be possible with the concentration process alone. In addition, by reducing lactose, for instance with diafiltration, may facilitate controlling the activity of the starter culture and pH. Controlling lactose also provides for the ability to control end product flavor due to lactose serving as a metabolic carbon source for starter cultures.

### Ion Exchange

Ion exchange may be used to remove select ions from the milk composition and/or concentrate select ions in the milk composition. Accordingly, ion exchange processes may be used to form ion-depleted or ion-enriched milk compositions. The milk composition may be loaded on to an ion-exchange column to bind and/or pass select cations or anions. For example, any one or more of calcium, sodium, potassium, chloride, phosphate, and citrate may be bound to or passed through an ion exchange column. When a desired ion is bound to a column, it may be eluted with an eluent and collected. In addition or alternatively, nanofiltration may be used to remove ions from the milk composition and/or concentrate select ions in the milk composition.

### Centrifugation

Centrifugation may be used to remove fat from the milk composition and/or concentrate select ions in the milk composition.

### Vat Removal

Vat processing may involve adding cultures or enzymes (e.g., rennet) to milk in a vat where the cultures and/or enzymes cause a physical phase change, e.g., coagulation of the milk, and whey may be separated from the curd.

### Enzyme Treatment

Enzymes may convert lactose to galacto-oligosaccharides and monosaccharaides. For instance, lactase, may be added to milk compositions to hydrolyze lactose into its constituent sugars—glucose and galactose. As provided herein, some lactose in the component-adjusted milk may be retained, and the enzymatic activity may be controlled by, for example, heat treatment to denature the enzyme prior to complete hydrolysis of the lactose. In addition or alternatively, lactase treatment at reduced temperatures and/or at a reduced pH may slow lactose conversion.

### Ultrafiltration

Ultrafiltration may remove at least some moisture, minerals and lactose from a milk composition while retaining all proteins, including whey proteins, as well as fat. Consequently, in ultrafiltration of milk, the ratio of fat:casein:whey protein is the same as that in milk. Similarly, performing other milk composition adjustment processes to produce an adjusted milk composition prior to ultrafiltration may result in retention of the same protein and fat ratios as in the adjusted milk composition. For example, where whey and lactose are removed in an adjustment process such as microfiltration, a subsequent step of ultrafiltration may maintain the same ratio of protein and fat from the microfiltration retentate while removing a portion of moisture and lactose.

Adjusting the milk composition via ultrafiltration may additionally involve one or more diafiltration steps based on the desired level of extraction of the serum or whey protein and lactose, as provided hereinabove.

### Reverse Osmosis

Reverse osmosis removes at least some moisture, from a milk composition while retaining other components. Accordingly, reverse osmosis may help produce concentrated milk compositions in which the total solids concentration has been increased. For example, reverse osmosis may produce a concentrated milk composition having about 25 wt % to 30 wt % total solids.

### Nanofiltration

Nanofiltration removes at least some moisture and minerals and salts from a milk composition while retaining other components. Accordingly, nanofiltration may help produce concentrated milk compositions in which the total solids concentration has been increased. For example, nanofiltration may produce a concentrated milk composition having about 25 wt % to 30 wt % total solids.

### Evaporation

Evaporation removes at least some moisture from a milk composition while retaining all other components. Accordingly, evaporation may help produce concentrated milk compositions in which the total solids concentration has been increased. In some implementations, evaporation may be conducted using a wiped-film evaporator, such as a GMM Pfaudler wiped-film evaporator for small scale settings. The evaporator may operate under vacuum, typically set to an absolute pressure between 40 mmHg and 25 mmHg. Evaporation may occur via heat transfer from a heated jacket, set between 140 °F and 180 °F with the heating media set as water, oil, or vacuum steam, transferred to a turbulent, thin layer of product in the evaporative section of the evaporator. A turbulent, thin layer may be achieved via a rotor within the evaporator, and for example the rotor may operate at a speed between 160-200 RPM in a small-scale setting. The product fed into the evaporator may have a total solids and 42% and 44%, at a temperature of about 85 °F to about 95 °F. The concentrated product may exit the evaporator, at a temperature between 70 °F and 90 °F, for instance depending on the operating vacuum pressure. The total solids of the product exiting the evaporator may be about 63% to about 67% total solids. It will be appreciated that evaporation may be conducted in large scale settings to remove moisture and achieve the desired target solids content while retaining other components, according to the present disclosure.

### Addition of Dairy Components

In further implementations, the milk composition may be adjusted by adding dairy components to the composition. For example, one or more of protein, protein-containing components (e.g., whey and casein), fat, lactose, solids nonfat, milk protein concentrate (MPC), and water, or combinations thereof, may be added to the starting milk composition to produce an adjusted milk composition that differs from the starting milk composition.

Accordingly, implementations may involve adjusting a milk composition such that an adjusted milk composition contains different ratios of milk components compared to the original milk composition. For example, the adjusted milk composition may have a reduced protein-to-fat ratio and/or a reduced lactose-to-fat ratio relative to the starting milk composition, such as whole milk.

Each adjustment process may be conducted at a suitable temperature and pressure, which may be an elevated temperature and/or pressure. For example, an adjustment process may be performed at about 125 °F to about 180 °F, about 155 °F to about 175 °F, about 140 °F to about 170 °F, about 140 °F to about 180 °F, or about 160 °F to about 180 °F. An adjustment process may be performed at about 24 to about 29.4 inches of mercury. In some implementations, the adjustment process may additionally include cooling the adjusted milk composition to a temperature of about 70 °F to about 94 °F. Adjustment through filtration may be up to 100 psig (gauge pressure), but may also be conducted at lower pressure while simultaneously achieving adjustment through evaporation.

### Example Process

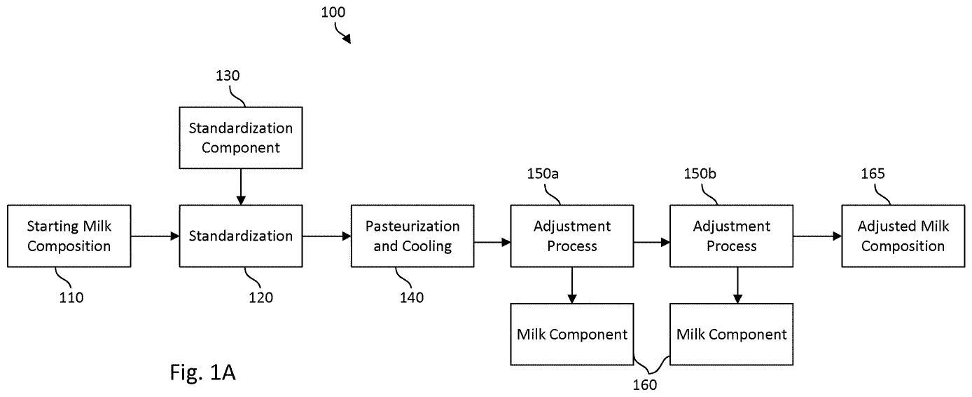

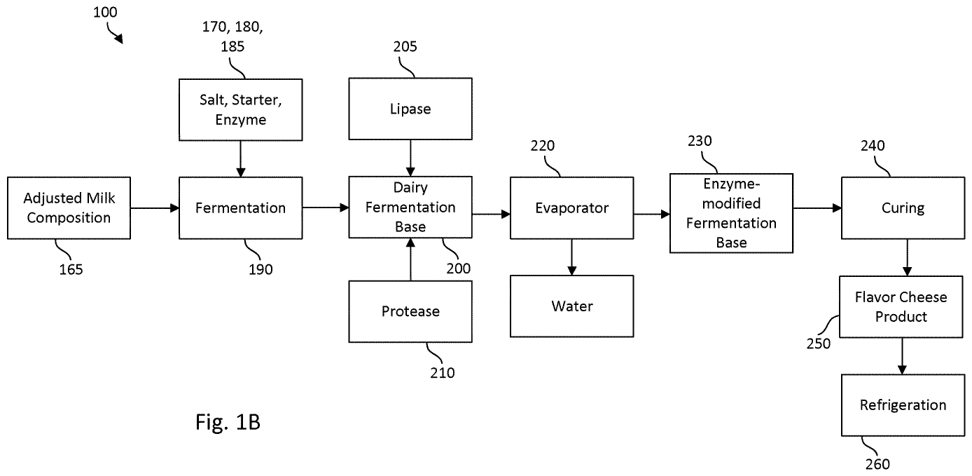

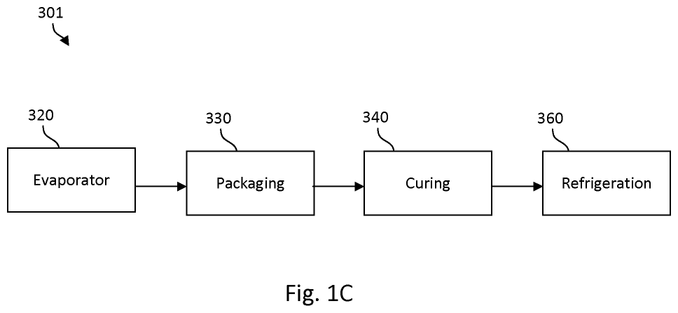

An example of milk composition preparation and adjustment process is provided in FIG. 1A. In the method 100, a starting milk composition 110, such as raw whole milk, is standardized 120 by the addition of one or more standardization components 130, such as cream and/or skim milk, to a targeted fat-to-protein ratio based on the desired final product composition. The standardized milk composition is then pasteurized and cooled 140, such as to about 130 °F. Then composition is then subjected to milk composition adjustment processes 150a, 150b, such as microfiltration and diafiltration, which causes the removal of at least one milk component 160, such as whey protein. The milk composition adjustment processes 150a, 150b lead to production of an adjusted milk composition 165.

In some implementations, following the adjustment of the milk composition by one or more of the disclosed processes, no dairy or milk component or composition (e.g., cream or skim milk) is added to or removed from the adjusted milk composition, other than the removal of moisture, until the finished product has been produced. In some implementations, no dairy or milk component or composition is added to or removed from the adjusted milk composition at least until fermentation and/or enzyme treatment, each as disclosed herein, is complete. Such minimal processing may help retain features of the adjusted milk composition that are desirable for conducting downstream processing steps such as fermentation or enzyme treatment, including the development of desirable products of those processing steps. Table 1 provides ranges of milk components in an example starting milk composition compared to an example adjusted milk composition produced by microfiltration.

TABLE 1

| | | Desired wt % Range |
|---|---|---|
| | | Adjusted Milk |
| | Expected wt % Range | Composition |
| Milk | Starting Milk | (microfiltration & |
| Component | Composition | ultrafiltration) |
| Total solids | 12.00-15.00 | 37.00-46.00 |
| Fat | 3.30-5.50 | 20.00-27.00 |
| SNF | 6.50-11.70 | 10.00-26.00 |
| Protein | 2.95-3.75 | 12.00-16.00 |
| Whey | 0.40-0.65 | 0.40-1.95 |
| Casein | 2.40-2.85 | 10.00-15.00 |
| Lactose | 4.10-5.10 | 0.70-1.60 |
| Water | 85.00-88.00 | 54.00-63.00 |

### Benefits of Adjusting Milk Compositions

The milk composition adjustment processes disclosed herein yield improved final products compared to other production methods performed in the absence of the disclosed adjustment processes. In some implementations, the adjustment processes reduce or remove whey proteins, such as by microfiltration or ultrafiltration of the starting milk composition, and the resulting final products have improved properties compared to products in which whey proteins have not been removed from the intermediate or final products. Improved properties may include one or more of better flavor development (e.g., added bitter flavor notes), better texture, desired consistency, better protein functionality in final products (e.g., when in a blend with process cheese) and desired melt characteristics.

For example, use of the disclosed adjusted milk compositions in cheese sauce final products, such as finished pasteurized cheese sauces or heat-treated cheese sauce products for food service operations, may produce cheese sauces with a desirable smooth consistency upon reheating. In contrast, ultrafiltration retains whey proteins from a starting milk composition in an intermediate concentrated product. When such intermediate concentrated product is used in cheese sauce final products, reheating of the cheese sauce products may denature the retained whey proteins. Denaturation may cause an undesirable flocculated or chunky, mashed potato-like consistency in the cheese sauce instead of the desired smooth consistency.

### Fermentation and Fermentate Production

With reference to FIGS. 1A and 1B, following one or more milk composition adjustment processes 150a, 150b, the adjusted milk composition 165 may have a solids content of about 37-46 wt %, such as about 38-42 or 42-46 wt %. The adjusted milk composition 165 may be salted 170, e.g., at about 0.5 to 3.0 wt %, about 2.0 to 3.0, or about 2.7 wt % on a dry basis. Salting the adjusted milk composition may help stabilize the adjusted milk composition during subsequent processing steps, such as fermentation. For instance, a salted microfiltration or ultrafiltration concentrate may facilitate avoiding phase separation during fermentation, while diafiltration may remove serum or whey protein and lactose to a desired level. In some implementations, salt may be added at elevated processing temperatures such as about 110 °F to about 140 °F to aid in the solubility of the salt during the addition process. Salting may also reduce the viscosity of the adjusted milk composition and intermediate materials produced during the production of the dairy products.

The adjusted milk composition 165 may additionally or alternatively be heat-treated and/or cooled to reduce the microbiological counts of any thermoduric or thermophilic bacteria that may present prior to subsequent culturing/fermentation process. Heat treatment may be to about 155 °F to about 175 °F, such as 165 °F for 15 seconds with a minimum of 162 °F, which may be followed by cooling to about 86 °F for mesophilic lactic acid bacteria or to about 110 °F for thermophilic lactic acid bacteria. Heat treatment after salting may help reduce the number of bacteria that may have grown during the milk composition adjustment process, such as when the milk composition adjustment process is conducted at an elevated temperature. Cooling the adjusted composition after heat treatment may help prepare the composition for fermentation, such as by reducing the temperature of the composition such that the residual heat will not damage or kill the cultures for fermentation. In one example, the adjusted composition is a microfiltration or an ultrafiltration concentrate, and it is salted, heat-treated, and cooled prior to fermentation. The salt may help the filtered concentrate avoid phase separation during fermentation.

One or more starter cultures 180 may be added to the adjusted milk composition 165, with or without salting 170, and with or without heat-treating and/or cooling. The starter culture(s) 180 may be added to one or more fermenters for fermentation 190 of the adjusted milk composition 165 by one or more starter cultures 180. The starter culture 180 may include a lactic acid producing culture, such as a cheese culture. Cheese cultures may be a bacterial culture or cultures capable of converting residual lactose in the adjusted milk composition to lactic acid. The cheese cultures may be added as pellets, such as frozen or freeze-dried pellets. Example cheese cultures include direct vat set cheese cultures, bulk starters, and the lactic acid producing culture Lactococcus lactis subsp. cremoris and Lactococcus lactis subsp. lactis (e.g., FC-211 from DSM Food Specialties B.V.). Other examples of cheese cultures may include nisin-producing lactic acid bacteria, such as Lactococcus lactis subsp. Cremoris, e.g., (D 029 from CSK Food Enrichment C.V.).

The cheese cultures (starters) may be added at about 0.001 wt % and about 0.5 wt % of the adjusted milk composition 165, between about 0.001 wt % and about 0.3 wt % of the adjusted milk composition 165, between about 0.002 wt % and about 0.2 wt %, between about 0.002 wt % and about 0.1 wt %, between about 0.001 wt % and about 0.1 wt %, between about 0.005 wt % and about 0.02 wt %, between about 0.01 wt % and about 0.02 wt % of the adjusted milk composition 165, less than about 0.5 wt %, less than about 0.4 wt %, less than about 0.3 wt %, less than about 0.2 wt % of the, less than about 0.1 wt %, less than about 0.05 wt %, less than about 0.04 wt %, less than about 0.03 wt %, less than about 0.02 wt %, or less than about 0.01 wt % of the adjusted milk composition 165. Cheese cultures at about 0.001-0.1 wt % may be adjunct levels and these small amounts may be in addition to regular starter cultures. The culture amount can range from very low or very high depending on the cell count per volume. For instance starters may be delivered based on Units of cells rather than by weight, and hence small amounts of starter may be added. Other factors involve whether the starter is a freeze-dried culture vs. a frozen can or frozen pellet vs. a bulk starter from a starter tank might use larger quantities. Accordingly, multiple starters including one or more adjunct starter cultures may be added to the adjusted milk composition 165.

Fermenters such as fermentation tanks may receive the adjusted milk composition 165 for in situ production of lactic acid. Fermenters may be swept surface fermenters, may be configured to mix and circulate the adjusted milk composition 165 and cheese cultures, and may operate with minimal air incorporation.

The fermenter may be gradually filled with the adjusted milk composition 165, for instance over a filling period. As the adjusted milk composition is added over the course of the filling period, fermentation 190 of the adjusted milk composition occurs by the one or more cultures 180 to cause in situ production of lactic acid. For instance, the filling period may extend for about 2 to about 9 hours, such as about 2, 3, 4, 5, 6, 7, 8, or 9 hours, or about 2 to about 8, about 3 to about 8, about 4 to about 8, about 5 to about 8, about 2 to about 6, about 3 to about 6, about 4 to about 6, about 3 to about 9, about 4 to about 9, about 5 to about 9, or about 6 to about 9 hours, and fermentation 190 may occur during all or a portion this time. Fermentation 190 may continue after the filling period such as for about 0 to about 96 hours, such as about 1, 2, 3, 4, 5, 6, 7, 8, 9, 10, 15, 20, 25, 30, 35, 40, 45, 50, 55, 60, 65, 70, 75, 80, 90 or 96 hours, such as about 1-20 hours, 2-15 hours, 3-12 hours, 4-10 hours, 5-10 hours, or 6-10 hours. For instance, if the tank filling time is 4 hours, it might take up to 4-10 hours to achieve a desired final pH, for an additional six hours of fermentation after the filling period. If the tank fill time is 4-9 hours the desired pH may be achieved during filling and thus no further fermentation may be needed after filling, or further fermentation up to any of the preceding fermentation times. Fermentation may occur in batches and fed-batches.

In some examples, the fermenter may be partially filled with the adjusted milk composition 165 prior to fermentation 190 by the addition of the cultures 180. For instance, at least about 5%, such as 10%, 15% or more of the fermenter may be filled with the adjusted milk composition prior to the addition of the culture or cultures 180. Alternatively, the culture or cultures 180 may be added at the beginning of the filling period when the fermenter is first filled with the adjusted milk composition 165.

In some cases, enzymes 185 such as rennet (See FIG. 1B) may be added to the fermenter. Other enzymes may include but are not limited to proteases, hydrolases such as lactase, lipases such as phospholipases, and deaminases such as glutaminase, protein glutaminase, glutamate dehydrogenase, and monoamine oxidase. Such other enzymes may be added in dry or liquid form, e.g., in a solution. Alternatively, one or more of these other enzymes may not be added to the fermenter, as provided further herein.

According to the present disclosure, heating of the fermenting adjusted milk composition or the fermentate to temperatures above 98 °F may be avoided to retain enzyme activity in the fermenting composition. That is, due to the activity of the starter culture causing the adjusted milk composition to drop in pH, enzymes are generated and their activity may be maintained by retaining the temperature of the fermentate at or below about 98 °F, such as at or below about 97.5 °F or lower, about 97 °F or lower, about 96 °F or lower, about 95 °F or lower, about 94 °F or lower; or at about 60 °F up to about 98 °F; or any of the ranges of about 60 °F, 65 °F, 70 °F, 80 °F, 85 °F, 90 °F, or 95 °F up to about 98 °F; or any of the ranges of about 98 °F, 95 °F, 90 °F, 85 °F, 80 °F, 75 °F, 70 °F, 65 °F down to about 60 °F. Maintaining the enzyme activity in the fermentate may facilitate pre-formation of cheese flavor development, which may be useful in producing the intensely flavored flavor cheese products of the present disclosure, and which may be particularly useful as a food ingredient in food manufacture to deliver high intensity cheese flavor as provided further herein. Accordingly, the enzyme activity of the fermenting adjusted milk composition may be maintained even after the fermentate is transferred from the fermenter to downstream processing, and the term “fermentate” may include an adjusted milk composition in which the fermenting activity is maintained in downstream vessels such as a balance tank, evaporator, and curing vessel. In some examples optimum temperatures of at which the starter culture is heated to during fermentation may depend on the type of starter, and for instance mesophilic starters may perform optimally at around 86 °F (30 °C) but may range from 64 °F to about 98.6 °F (18 °C to 37 °C) for growth and pH development; while thermophilic acidifying bacteria range from 86 °F to about 113 °F (30 °C to 45 °C) for growth and pH development.

In other cases, the fermenting adjusted milk composition or the fermentate may be heat treated by heating to about 100 °F to about 165 °F in the fermenter or post-fermentation, such as at least about 165 °F to deactivate the cheese cultures. In examples, the heating may occur after all or a portion of a fermentation period of the fermenting adjusted milk composition or the fermentate, and heating may be to at least 105 °F. In some examples, heating of the fermenting adjusted milk composition or the fermentate may be conducted at an end of a fermentation period to thereby retain cultures in the fermentation tank during the fermentation period and then cease fermentation thereafter. For instance, mesophilic cultures may be maintained at a fermentation temperature of 86 °F during the fermentation period, and heating to elevated temperatures above this temperature may cease the activity of the culture. For instance, heating to elevated temperatures above 120 °F may damage the starter and thereby slow or cease culture activity.

Upon the fermenting adjusted milk composition dropping to a target pH of about 4.4 to 5.8 from a starting pH of about 6.7 to about 6.3, the fermenting adjusted milk composition may be a fermentate, e.g., a fermented adjusted milk composition, which may also be referred to as a dairy fermentation base 200 (See FIG. 1B).

In some cases, the dairy fermentation base may be further processed, such as through shearing prior to being transferred away from the fermenter. For instance, the dairy fermentation base in the fermenter may be subjected to shear mixing and/or shear pumping during all or a portion of the fermentation process. During transfer of the dairy fermentation base 200 out of the fermenter or further processing, the dairy fermentation base 200 may be maintained at the aforementioned temperatures and temperature ranges provided above in connection with the temperatures during fermentation, for instance, in order to maintain the activity of the cheese cultures.

According to the present disclosure, after exiting the fermenter, e.g., at the end of fermentation 190, the dairy fermentation base 200 having a temperature of about 60 °F to about 98 °F may be mixed with an exogenous enzyme slurry or solution to cause accelerated flavor production in the dairy fermentation base. For instance, the exogenous enzyme slurry may be incorporated into the dairy fermentation base 200 after leaving the fermenter, and just prior to, or at the time of, evaporation. The exogenous enzyme slurry may include one or more lipases 205 (e.g., phospholipase), one or more proteases 210 or both, and the exogenous enzyme slurry is sometimes referred to as the enzyme slurry 205, 210.

Lipases 205 in the enzyme slurry 205, 210 breakdown fat globules into free fatty acids resulting in fat-derived flavor fragments. Lipases 205 may include but are not limited to plant, animal, microbial and/or fungal lipases, and may be added post-fermentation at levels of about 0.001 to about 0.5% of the dairy fermentation base 200, such as about 0.005, about 0.01, about 0.02, about 0.03, about 0.04, about 0.05, about 0.1, about 0.2, about 0.3, about 0.4 or about 0.5 wt % of the dairy fermentation base 200, or about 0.001 to about 0.01, about 0.02, about 0.03. about 0.04, about 0.05 wt %, about 0.1, about 0.2, about 0.3, about 0.4 or about 0.5 wt % of the dairy fermentation base. This is in contrast to the small amount of lipase that may be added to the fermenter, which may be up to about 0.1 wt % of the adjusted milk composition, an amount insufficient to intensify flavor in the cheese product. At this level, however, the lipase activity negatively impacts the starter culture function. In some cases, little or no lipase is added to the fermenter due to the lipase generating free fatty acids which function as antimicrobial, and can inactivate the starter culture in the fermenter.

Proteases 210 in the enzyme slurry 205, 210 break down proteins resulting in protein-derived flavor fragments. Proteases 210 may include but are not limited to such as plant, animal, microbial and/or fungal proteases, endoproteases, exoproteases, hydrolyzed vegetable protein, and may be added post-fermentation at levels of about 0.001 to about 0.5 wt % of the dairy fermentation base 200, such as about 0.005, about 0.01, about 0.02, about 0.03, about 0.04, about 0.05 wt %, about 0.1, about 0.2, about 0.3, about 0.4, about 0.5, about 0.6 or about 0.7 wt % of the dairy fermentation base 200, or a range of about 0.001 up to about 0.01, about 0.02, about 0.03. about 0.04, about 0.05, about 0.1, about 0.2, about 0.3, about 0.4 or about 0.5, about 0.6, about 0.7 wt % of the dairy fermentation base 200. This is in contrast to protease that may be added to the fermenter 190, which is insufficient to intensify flavor in the cheese product. Particularly, addition of proteases to the fermenter may cause undesirable coagulation of the milk proteins causing processing issues in some instances.

Rennet is a specific type of protease 210 and only clips kappa casein and may serve to coagulate the dairy fermentation base 200 to provide specific flavor notes to the protein-derived flavor fragments, and rennet may be added post-fermentation at about 0.002 to about 0.006 wt %, or about or at least about 0.001, 0.002, 0.003, 0.004, 0.005 or 0.006, 0.007, 0.008 wt % of the dairy fermentation base 200. The rennet liquid concentrate may be a liquid chymosin preparation derived from a selected strain of the dairy yeast Kluyveromyces lactis (e.g., Maxiren D/S). The rennet liquid concentrate may be about 0.00066 wt % to about 0.02 wt %, about 0.00165 wt % to about 0.0132 wt %, about 0.0033 wt % to about 0.0099 wt %, about 0.005 wt % to about 0.00825 wt % of the adjusted milk composition, or about 0.0066 wt % of the adjusted milk composition. The rennet liquid concentrate may have a minimum clotting activity per lb. of the adjusted milk composition of about 1.65 to about to 49.6 ICMU/ml (International Milk Clotting Unit/ml), or about 16.52 ICMU/ml, where one milk-coagulating unit (U) is defined as the amount of the rennet enzyme that coagulates 10 mL of reconstituted skimmed milk powder at 30 °C in 100 seconds. Although rennet is added, the presence of protease may be responsible for providing additional flavor impact.

While some enzymes including protease, lipase and/or rennet may be added to the fermenter during fermentation 190, the amount added is insufficient to intensify flavor in the cheese during the curing period. As provided herein, the enzymes introduced to the dairy fermentation base 200 in the exogenous enzyme slurry 205, 210 post-fermenter are at relatively high amounts and serve as a flavor intensifier. During evaporation 220 and curing 240, the protease(s) and/or lipase(s) in the dairy fermentation base 200 cleave proteins and/or fats therein breaking them down into flavor fragments.

In some implementations, the composition in the fermenter 190 may be free of lipase, protease and/or rennet, and one or more or all of these may instead be introduced after the dairy fermentation base 200 has moved downstream from the fermenter 190. For instance, rennet may be an unnecessary additive during fermentation 190 because, in contrast to traditional cheese making where rennet may be added to the fermenter, e.g., to add texture to the product, due to the traditional cheese product being intended for consumption as-is, the flavor cheese products produced according to implementations of the present disclosure have a flavor profile that is too intense for consumption as-is. For instance, the flavor cheese products of the present disclosure are typically consumed after its addition to a comestible base such that the finished product contains the flavor cheese product at a much lower amount than typical cheese and, for instance, only be present at about 0.5 to about 3 wt % of the finished solid product or at about 1.0 to about 5 wt % of a finished sauce product.

Although the enzyme slurry 205, 210 includes proteases, lipases and/or rennet, it will be understood that other enzymes may be added to the dairy fermentation base 200 in addition or as an alternative. Other enzymes may include but are not limited to hydrolases such as lactase, and deaminases such as glutaminase, protein glutaminase, glutamate dehydrogenase, and monoamine oxidase. Such other enzymes may be added in dry or liquid form.

Introduction of the exogenous enzyme slurry 205, 210 post-fermenter, e.g., to a vessel or fluid line containing the dairy fermentation base 200 that is the separate from the fermentation vessel, allows a significant quantity of enzymes to be incorporated without affecting the starter in the cheese starter in the fermentation stage, while permitting the delivery of the exogenous enzyme slurry 205, 210 to facilitate development of a highly flavored flavor cheese product as provided herein. This is in contrast to adding the exogenous enzyme slurry 205, 210 during fermentation 190, which could pre-maturely terminate the starter culture and cell destruction. According to the present disclosure, adding the exogenous enzyme slurry 205, 210 post-fermentation allows for full cheese culture development before introduction of enzymes that otherwise might promote antimicrobial lipase activity detrimental for the starter culture, but necessary for flavor development of the flavor cheese products of the present disclosure.

Upon receiving the exogenous enzyme slurry 205, 210, the dairy fermentation base 200 may have a solids content of about 37-46 wt %, such as about 38-42 wt % or 42-46 wt %. The enzymes from the slurry, and optionally from the starter culture, remain viable and active during and after evaporation and cause flavor generation, especially during curing 240.

In the evaporator 220, the temperature is maintained below 120 °F, e.g., from about 60 °F up to about 120 °F, or from about 75 °F to about 94 °F. For instance, the evaporator may subject the composition to vacuum such that evaporation occurs at low temperatures, which allows the enzyme slurry 205, 210 in the dairy fermentation base 200 to remain active.

The exogenous enzyme slurry 205, 210 may be introduced by injection into one or more feed lines downstream from the fermenter (FIG. 1B). For instance, the exogenous enzymes may be incorporated in-line into a fluid line that feeds the dairy fermentation base 200 to an evaporator 220 or may be fed into the evaporator 220. Similarly, such exogenous enzyme slurry may be incorporated into a balance tank arranged between the fermentation tank and the evaporator. In alternative embodiments, the exogenous enzyme slurry 205, 210 or portions thereof may instead be added post-evaporator.

In some cases, one or more pumps may be used to inject the exogenous enzyme slurry 205, 210. For instance, separate pumps such as peristaltic pumps or positive displacement pumps may be used to inject separate supplies of a lipase 205 slurry and a protease 210 slurry, optionally containing rennet. The slurries may continue to be separate until injected into the dairy fermentation base 200, or may be combined just prior to being fed into the dairy fermentation base 200. Injection in doses or in a continuous stream may facilitate even distribution in the enzyme(s) into the dairy fermentation base 200 as provided further herein. In some examples, rennet may be added to the dairy fermentation base 200 separately from the lipase 205 and protease 210, such as via a separate rennet supply and delivery source, e.g., pump.

Addition of the lipase 205 and/or protease 210 with the dairy fermentation base 200 may be accomplished by metering, e.g., dosing, or adding the enzyme slurry 205, 210 in a stream, such as a continuous stream or an intermittent stream. A plurality of doses of the enzyme slurry may be added during a filling period of the evaporator 220 while the dairy fermentation base 200 is added thereto. For instance, the enzymes in the enzyme slurry 205, 210 may be separately added in doses or intermittently once every minute during a dosing period, or once every 10, 20, 30, 40, 50, 60, 70, 80, 90, 100, 110, or 120 seconds during the dosing period. Once the dosing period begins, the enzyme slurries may be dosed, e.g., injected as a pre-defined doses, or added as a continuous or intermittent stream for the duration of the filling period, or for a portion thereof. When provided separately, the enzyme slurries may be added at different, regular time intervals and differing amounts relative to each other, for instance depending on the final flavor notes desired in the flavor cheese product. Dosing may be continuous, e.g., the time intervals between dose delivery may be the same over the dosing period.

In some implementations, the dosing period may continue after the filling period ends. In some examples, the dosing period may run concurrently with the entire filling period.

Alternatively, the dosing period may run for 5% to 90% of the filling period, such as about, or at least about, 5%, 10%, 15%, 20%, 25%, 30%, 35%, 40%, 45%, 50%, 55%, 60%, 65%, 70%, 75%, 80%, 85%, 90%, or 95% of the filling period, or about 10-90%, 10-50%, 50-90%, 20-60%, 60-90%, 30-70%, 70-90%, 10-40%, 40-90%, or any range between the aforementioned filling period percentages.

All or at least a portion of the dosing period may overlap with the filling period. For instance, the dosing period may continue after the filling period has ended. In examples, the filling period may include a first portion and a second portion following the first portion, and the dosing period may begin during the first portion of the filling period. For instance, the first portion may be the first half of the filling period, and the second portion may be the second half of the filling period, and the dosing period may begin during the first half of the filling period.

During evaporation in the evaporator 220, at least a portion of water is removed from the dairy fermentation base 200 treated with the enzyme slurry 205, 210. The evaporator may remove moisture by heating the composition to low evaporations temperatures below about 120 °F, or within the range of about 60 °F to at or below about 120 °F, such as about 80 °F to 115 °F, about 70 °F to about 98 °F, about 75 °F to about 97 °F, or about 75 °F to about 94 °F. The evaporator may be a wiped film evaporator configured to operate under vacuum pressure. In the evaporator 220, the composition may be continuously transferred by blades, such as by a mutator/wiper shaft of a wiped film evaporator, a thin film evaporator, a spinning cone evaporator, or an evaporative scraped surface heat exchanger, and so on, to form a thin film while maintaining the composition at the evaporation temperatures via heat transfer walls. Concentrating via wiped film evaporation may facilitate production of a higher the solids content product as disclosed herein, or may be used subsequent to production of the food product.

After removal of moisture from the enzyme-treated fermentation base 200 in the evaporator 220, an enzyme-modified fermentation base 230 may result, which may have a moisture and solids content corresponding to the standard identity of cheese such as that of cheddar cheese. For instance, the enzyme-modified fermentation base 230 may have a moisture content of about 34 and up to 40 wt %, and a solids content of about 60 to 66 wt %. The fat content may be about 30 to about 33 wt %, protein content may be about 18 to about 22 wt %, and lactose content may be about 0.75 to about 2.0 wt % of the enzyme-modified fermentation base 230.

In alternative embodiments, the exogenous enzyme slurry 205, 210 or portions thereof may instead be added post-evaporator to produce the enzyme-modified fermentation base 230. For instance, slurries of lipase 205 and/or protease 210 may be added to moisture-adjusted fermentation base 200 after exiting the evaporator 220, such as using an inline mixer to blend the compositions to form the enzyme-modified fermentation base 230.

The enzyme activity of the enzyme-modified fermentation base 230 remains active due to the low evaporation temperatures in the evaporator 240 and the composition with active enzyme activity may be subjected to curing 240.

During curing 240, the enzyme-modified fermentation base 230 is cured and ripened by the active enzymes to produce a finished flavor meeting the final flavor of an enzyme modified cheese with the composition of a standard of identity cheddar cheese useful in connection with food manufacture. Curing 240 may be conducted in an environment that may be temperature controlled and/or humidity controlled. In some cases, the enzyme-modified fermentation base 230 is packaged prior to curing. The curing 240 may be conducted during a curing period and may correspond to a period of time to achieve a fully ripened flavor. For instance, the curing period may be over several consecutive days or weeks, such as about 1 to 6 weeks, 2 to 4 weeks, 3 to 4 weeks, and so on. The temperatures of curing 240 may be at elevated temperatures such as about 38 °F to about 75 °F or about 45 °F to about 70 °F. After the curing period, the finished flavor of the cheese product has unusually high levels of enzymes that under normal circumstances would be detrimental to the starter system during fermentation 190, but according to the present disclosure, when ripened under appropriate conditions during curing 240 forms a finished flavor cheese product 250 that is 30 times to 50 times the flavor concentration of conventionally made cheddar cheese. It has been discovered that the enzyme activity of lipases and proteases results in an increased free fatty acid content, as well as a changed proportion of protein, e.g., the amount of intact protein with percent non-protein nitrogen (NPN) being increased with a proportional decrease in casein, in the flavor cheese product 250 compared to traditional cheese.

The increased levels of free fatty acids in the flavor cheese product 250 results in the acid degree value (ADV) of the flavor cheese product 250 being at least 2, at least 3, at least 4, at least 5, at least 6, at least 7, at least 8, at least 9, or at least 10; or a range of about 5 or 10 up to about 300, about 10 to up about 270, about 10 to about 200, 10 to 100, 10 to 50, 10 to 30, or about 5 or 10 to about 20, 30, 40, 50, 60 or 70, or up to about 10, 50, 100, 200, 300. This is in contrast to regular cheese with a typical ADV of about 0.25 to 0.67. ADV was measured according to Standard Methods for the Examination of Dairy Products (SMEDP) 16th Edition 15.2.

The overall protein composition having a changed proportion in the amount of intact protein, i.e., with an increasing level of NPN, and a proportional decrease in casein, results in the flavor cheese product 250 containing NPN at least about 2.0 to about 5%, or at least about 1.5, 2.0, 2.5, 3.0, 3.5, or about 3.6% or higher and up to about 4.0, 5.0, 6.0, 7.0% (with a proportional decrease in casein). This is in contrast regular cheese containing NPN at about 0.75% to 1.26%.

The resulting the flavor cheese product 250 allows food products to incorporate the highly flavored products of the present disclosure at very low levels to deliver the flavor impact of conventional make cheese while using small quantities of the presently disclosed flavor cheese product 250.

After curing 240, the flavor cheese product 250 may be subjected to refrigeration 260, packaging or re-packaging and so on. Refrigeration 260 may cause the enzyme activity to slow down or cease in the flavor cheese product 250. Temperatures of the flavor cheese product 250 during refrigeration 260 may be about 38 °F to about 45 °F, which may slow down enzyme activity and facilitate controlling a finished flavor of the flavor cheese product 250.

Turning to FIG. 1C, according to another exemplary embodiment, a flavor cheese product 250 may be produced according to the system 301 of FIG. 1C. Aspects of system 301 that are the same as method 100 include numbering corresponding to FIGS. 1A and 1B. According to this embodiment, the dairy fermentation base 200 may be fed to an evaporator 320, be subjected to packaging 330, curing 340, and refrigeration 360.

During evaporative food processing at the evaporator 320, the dairy fermentation base 200 may be converted to an enzyme-modified fermentation base 230 due to the conditions in the evaporator not reaching a temperature sufficient to kill the active lipases and/or proteases from the exogenous enzyme slurry, thus allowing the lipase(s) and/or protease(s) to continue to act on the dairy-derived fats and/or proteins. The enzyme-modified fermentation base 230 thus may not be subjected to direct steam injection and may not be subjected to other forms of heat treatment sufficient to kill active lipase(s) and/or protease(s) when moisture is removed therefrom through the evaporative process. For instance, when moisture is removed through an evaporative process, the moisture may be removed in the absence of external heat being added directly to the composition in the evaporator 320. Accordingly, during evaporative processing at the evaporator 320, the composition may not reach a temperature of about 130 °F, 125 °F, 120 °F, 115 °F, 110 °F, 105 °F, 100 °F, 98 °F, 94 °F, 86 °F, 80 °F, 76 °F, 72°, or 60 °F according to various embodiments; or may reach temperatures of up to about 120 °F and down to about 60 °F, about 98 °F to about 60 °F, or any of the ranges of about 75 °F up to about 115 °F, 110 °F, 105 °F, 100 °F, 94 °F, 86 °F, 80 °F, 76 °F; or any of the ranges of about 120 °F down to about 110 °F, 105 °F, 100 °F, 86 °F, 80 °F, 76 °F, or 72 °F, or any of the ranges of about 110 °F down to about 105 °F, 100 °F, 86 °F, 80 °F, 76 °F, or 72 °F, or any of the ranges of up to about 105 °F and down to about 100 °F, 86 °F, 80 °F, 76 °F, or 72 °F; or any of the ranges of up to about 100 °F and down to about 86 °F, 80 °F, 76 °F, or 72 °F; or any of the ranges of up to about 86 °F and down to about 80 °F, 76 °F, 72 °F, or 60 °F, and so on.

As noted above, during evaporative processing under vacuum pressure, the enzyme-modified fermentation base 230 may not reach at least one of the listed temperatures or temperature ranges according to various embodiments. To achieve evaporation of moisture to result in the enzyme-modified fermentation base 230 without causing the enzyme-modified fermentation base 230 to reach at least one of the listed temperatures or temperature ranges, the evaporation chamber may be configured as a vacuum chamber and may be operate under a vacuum pressure. For example, the evaporation chamber may be configured operate under of a vacuum pressure of between about 24.5 and about 29.3 inches of mercury, between about 25 and about 29.2 inches of mercury, between about 26.0 inches of mercury and about 29.0 inches of mercury, between about 27.0 and about 28.0 inches of mercury, greater than about 24.1 inches of mercury, greater than about 26.2 inches of mercury, greater than about 27.8 inches of mercury, greater than about 28.7 inches of mercury, greater than about 28.9 inches of mercury, or greater than about 29.0 inches of mercury. It is noted that: at a vacuum pressure of 24.04 inches of mercury, the enzyme-modified fermentation base 230 being evaporated would not exceed 140 °F; at a vacuum pressure of 26.28 inches of mercury, the enzyme-modified fermentation base 230 being evaporated would not exceed 122 °F; at a vacuum pressure of 27.75 inches of mercury, the enzyme-modified fermentation base 230 being evaporated would not exceed 104 °F; at a vacuum pressure of 28.67 inches of mercury, the enzyme-modified fermentation base 230 being evaporated would not exceed 86 °F; at a vacuum pressure of 28.92 inches of mercury, the enzyme-modified fermentation base 230 being evaporated would not exceed 80 °F; at a vacuum pressure of 29.02 inches of mercury, the enzyme-modified fermentation base 230 being evaporated would not exceed 76 °F; and at a vacuum pressure of 29.12 inches of mercury, the enzyme-modified fermentation base 230 being evaporated would not exceed 72 °F.

Evaporative processing at the evaporator 320 may reduce the moisture content in the enzyme-modified fermentation base 230 to a desired level. For example, evaporator processing at the evaporator may reduce the moisture content in the enzyme-modified fermentation base 230 to between about 30 wt % and about 70 wt % of the enzyme-modified fermentation base 230, between about 35 wt % and about 65 wt % of the enzyme-modified fermentation base 230, between about 40 wt % and about 60 wt % of the enzyme-modified fermentation base 230, between about 35 wt % and about 45 wt % of the enzyme-modified fermentation base 230, between about 45 wt % and about 55 wt % of the enzyme-modified fermentation base 230, between about 55 wt % and about 65 wt % of the enzyme-modified fermentation base 230, about 40 wt % of the enzyme-modified fermentation base 230, about 45 wt % of the enzyme-modified fermentation base 230, about 50 wt % of the enzyme-modified fermentation base 230, about 55 wt % of the enzyme-modified fermentation base 230, about 60 wt % of the enzyme-modified fermentation base 230, less than about 60 wt % of the enzyme-modified fermentation base 230, less than about 55 wt % of the enzyme-modified fermentation base 230, less than about 50 wt % of the enzyme-modified fermentation base 230, less than about 45 wt % of the enzyme-modified fermentation base 230, or less than about 40 wt % of the enzyme-modified fermentation base 230. Evaporative processing may reduce the moisture content of the food by between about 5 wt % and about 40 wt %, between about 5 wt % and about 20 wt %, or between about 20 wt % and about 40 wt % according to different embodiments.

The resulting moisture-adjusted enzyme-modified fermentation base 230 may accordingly be a dairy-based product with a total solids content of about 30 wt % and about 70 wt % of the enzyme-modified fermentation base 230, with the balance being moisture. A fat content of the moisture-adjusted enzyme-modified fermentation base 230 may be about 15 wt % to about 40 wt %, about 30 wt % to about 40 wt %, or about 35 wt % to about 40 wt %. Protein may be about 15 wt % to about 25 wt %, lactose about 2 wt % to about 8 wt % of the moisture-adjusted enzyme-modified fermentation base 230.

After leaving the evaporator 320, the moisture-adjusted enzyme-modified fermentation base 230 may be subjected to packaging 330, such as air-tight packaging.

Curing 340 may be conducted during a curing period and may correspond to a period of time to achieve a fully ripened flavor. For instance, the curing period may be over several consecutive days or weeks, such as about 5 to about 30 days, 1 to 6 weeks, 1 to 5 weeks, 1 to 4 weeks, 2 to 4 weeks, 3 to 4 weeks, or up to 1 month, 2 months, 3 months, 4 months, 5 months, or 6 months. The temperatures of curing 340 may be at elevated temperatures such as about 35 °F to about 80 °F, or about 38 °F to about 75 °F. After the curing period, the finished flavor of the cheese product has unusually high levels of enzymes that under normal circumstances would be detrimental to the starter system during fermentation 190, but according to the present disclosure, when ripened under appropriate conditions during curing 340 forms a finished flavor cheese product 250 that is 30 times to 50 times the flavor concentration of conventionally made cheddar cheese.

For instance, the resulting flavor cheese product 250 may accordingly be a dairy-based product with a total solids content of about 30 wt % and about 70 wt %, with the balance being moisture. For instance, the total solids content may be about 50 to about 70 wt %, about 60 to about 70 wt %, or about 60 to about 66 wt % of the flavor cheese product 250. A fat content of the flavor cheese product 250 may be about 15 wt % to about 40 wt %, about 30 wt % to about 40 wt %, or about 30 wt % to about 35 wt % of the flavor cheese product 250. Protein may be about 15 wt % to about 25 wt %, or about 18 wt % to about 22 wt % of the flavor cheese product 250, lactose may be about 2 wt % to about 8 wt % of the flavor cheese product 250. The ADV and % NPN of the flavor cheese product 250 may be increased relative to regular cheese, as provided herein. This allows food products to incorporate the highly flavored products of the present disclosure at very low levels to deliver the flavor impact of conventional make cheese while using small quantities of the presently disclosed flavor cheese product 250.

After curing 340, the flavor cheese product 250 may be subjected to refrigeration 360, which causes the enzyme activity to slow down or to cease in the flavor cheese product 250. In addition or alternatively, the flavor cheese product 250 may be subjected to deep cooling or freezing for instance to slow enzyme activity for more extended periods before end use.

### Production of Food Products

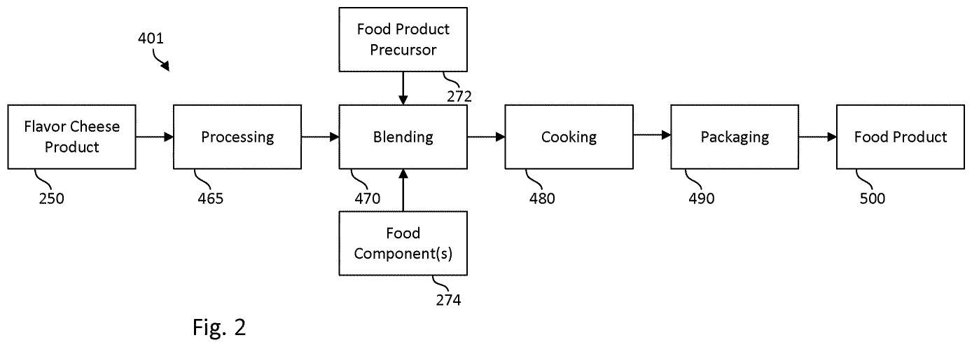

The flavor cheese product 250 be a final product, or may be further processed to produce one or more food products. For instance with reference to the method 401 of FIG. 2, the flavor cheese product 250 may be subjected to processing 465 and for instance may be divided through spray drying, grinding, shredding, and so on. Processing 465 the flavor cheese product 250, in examples, involves preparing a slurry and spray drying to form a powder. The slurry may additionally contain fillers, acidulants, flavors, emulsifiers and so on. Spray drying may involve using nozzles to atomize the slurry and drying atomized particles, for instance using tower spray dryers and fluid beds. Dairy products produced from spray drying are disclosed in US 2008/0299279 A1, the contents of which is incorporated by reference for any useful purpose.

The flavor cheese product 250 may be subjected to blending 470 with food product precursors 272 and/or food components 274 components including but not limited to, dairy powders (e.g., buttermilk powder), milkfat (e.g., concentrated milk fat (CMF)), salt, lactic acid, added cheese (e.g., natural, process, enzyme modified cheese, and combinations), sorbic acid, cultured pasteurized milk, skim milk, whole milk, whey, sweet whey, or their dried equivalents, milk minerals, sugar, and/or water. The components may additionally include vegetables or vegetable components, meats and/or meat flavoring, and/or flavor additives, chelators and/or hydrocolloids. In embodiments, where added cheese is included, the cheese may comprise a blend of two, three, four or more cheese varieties, one or more of which may be natural or processed. Example cheese varieties include, but are not limited to, cheddar, Gouda, Swiss, pepper jack, mozzarella, Muenster, cotija, and/or Monterey jack. Product components may also include plant-based components such as canola, sunflower, and/or soy products, which may be provided in the form of various extracts, powders and/or oils. Other components may include natural flavors, emulsifying salts (sodium citrate, sodium phosphate and/or trisodium phosphate), and dairy derived emulsifying salts derived from the starting milk compositions. The blended components with the fermentate may be used to produce an enzyme modified cheese, for example. In some cases, any of the aforementioned components may be excluded from the compositions of the present disclosure.

Moisture adjusting the flavor cheese product 250 alone or in combination with the various aforementioned components, may involve feeding the flavor cheese product 250 or blend thereof to an evaporator vessel where moisture in the composition is evaporated to form a concentrated composition with a reduced moisture content. In some implementations, the evaporator vessel may be configured as a vacuum chamber and may be operated under vacuum pressure below standard atmospheric pressure, for instance from about 16 inHg to about 29.5 inHg (which corresponds to about 176 °F to 53 °F boiling point of water), or from about 20 inHg to about 28 inHg, or from about 24 inHg to about 29.92 inHg, or about 28 inHg.

Following moisture removal, the moisture-adjusted flavor cheese product 250 or blend thereof may be blended with one or more of the various components disclosed herein above. For instance, the flavor cheese product 250 may optionally be blended with components such as dairy ingredients (dairy powders, milk fat), salt and water, enzyme modified cheese, natural flavors. For instance, the additional components may facilitate production of a cheese preblend used for the production of process cheese products.

The flavor cheese product 250 or without moisture-adjustment and blending, may be subjected to cooking 480, and steam may be injected into a cooker, e.g., a kettle-type cooker. Emulsifying salts or other components may optionally be added to the cooker and may be further blended, for example to produce a pasteurized process cheese, spread, or product. In some examples, direct steam addition into the cooker may cook the fermentate to pasteurization temperatures and held in the cooker to achieve pasteurization.

The flavor cheese product 250, with or without moisture-adjustment, blending with other food components to form a blend 470, and cooking 480, may be sealed or packaged 490 and stored at refrigeration temperatures, e.g., about 39 °F (4 °C), to produce a food product 500, such as a process cheese, which may include but is not limited to as a process cheese loaf, a process cheese spread, ingredient cheese, cheese sauces, heat-treated cheese sauces, pasteurized cheese sauces, process cheese, pasteurized process cheese, dairy spreads, pasteurized process cheese spreads, pasteurized process cheese products, pasteurized process cheese food, pasteurized process cheese product or pasteurized blended cheese, and precursors or intermediates to production of any of the foregoing. In some implementations, prior to packaging, the flavor cheese product 250, blend 470, food product 500 or any intermediate thereof may be spread as a molten product in a sheet like manner on chilled belts for rapid cooling to produce slice on slice cheese products as the food product 500. In other examples, the flavor cheese product 250, blend 470, food product 500 or any intermediate thereof may be formed into blocks, added to vessels, further processed, and so on.

### Process Cheese Products

Process cheese and other food products may be formed of, or contain, the flavor cheese product 250, blend 470, food product 500 or any intermediate thereof of the present disclosure. For example, the flavor cheese product 250 may account for about 0.5 to about 5 wt % of such products, such as about 0.5 to 3 wt % or 1.0 to about 5.0 wt %. The amount of the flavor cheese product 250 may vary, and may depend on factors such as the specifically desired flavor, the amount of flavor impact from the formula or application as an ingredient for use in a secondary formula, flavor profile desired in the finished product.

When the food products are provided as process cheese products, these may be solid at room temperature, while process cheese spread products may be non-solid at refrigeration and room temperatures and may be spreadable at these temperatures. For example, the non-solid physical state of the process cheese spread composition may be defined by a viscosity greater than that of a liquid, but less than a solid. For example, the cheese spread products may have a thick consistency at room temperature, e.g., about 68 °F (20 °C) to about 77 °F (25 °C), with a viscosity ranging from about 100,000 cPs to about 160,000 cPs, depending on the exact temperature. The non-solid state of the process cheese spread products may be further characterized by the composition being spreadable at refrigeration temperatures, and at room temperature the composition cannot be readily poured from a container.

A moisture level of the process cheese products, e.g., process cheese loaf products, may range from about 35 wt % to about 45 wt %, such as about 36 wt % to about 45 wt %, about 40 wt % to about 45 wt %, about 42 wt % to about 45 wt %. For example, block process cheese may have a moisture range of about 35 wt % to about 40 wt %, while sliced, or slice on slice, process cheese may have a moisture range of about 40 wt % to about 45 wt %. A moisture level of the process cheese spread products may range from about 48 wt % to about 60 wt %, such as about 50 wt % to about 60 wt %, about 52 wt % to about 60 wt %, or about 54 wt % to about 60 wt %, about 48 wt % to about 55 wt %, about 48 wt % to about 52 wt %, or about 48 wt % to about 51 wt %. In some implementations, the moisture may be derived solely from the fermentate(s), or some moisture may be added moisture (e.g., in the form of a liquid such as water, water from condensing steam from a direct steam injection cooking process, or a dairy component such as milk or cream). Moisture levels may impact product viscosity, such that the greater the moisture level, the less viscous, and vice-versa. A moisture level of the cheese sauce products may range from about 55 wt % to about 65 wt %, about 45 wt % to about 70 wt %, about 50 wt % to about 70 wt %, about 50 wt % to about 60 wt %, about 60 wt % to about 70 wt %, or about 50, 52, 55, 58, 60, 52, 65, 67, or 70 wt % of the cheese sauce product.

Salt may be included in the process cheese, and the amount may depend on the desired taste and/or nutritional content of the product. For example, low-sodium or reduced sodium varieties may include less salt than other varieties. In various embodiments, the salt content of the products may range from about 0.1 wt % to about 3 wt %, about 0.2 wt % to about 2 wt %, or about 0.3 wt % to about 0.8 wt %.

Dairy products produced from fermentation and evaporation are also disclosed in US 2022/0132879 A1, the contents of which is incorporated by reference for any useful purpose.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. In some instances, the term “about” includes values up to and including 10% less than and 10% greater than the recited value.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of producing a flavor cheese product, the method comprising:
adding an adjusted milk composition to a fermentation tank, wherein the adjusted milk composition contains at least one of a reduced protein-to-fat ratio or a reduced lactose-to-fat ratio relative to a starting composition of milk;
fermenting the adjusted milk composition in the fermentation tank to cause in situ production of lactic acid, wherein during the fermenting the adjusted milk composition is free of rennet;
transferring the fermented adjusted milk composition from the fermentation tank;
adding a lipase, a protease or both to the transferred fermented adjusted milk composition having a temperature of about 60 °F to about 98 °F;
evaporating at least a portion of water therefrom at a temperature of about 80 °F to about 120 °F to form a cheese composition; and
curing the cheese composition for a curing period at a temperature between about 38 °F to about 75 °F, wherein the curing period is about 3 to 6 weeks, wherein enzymatic activity of the added lipase, protease or both is maintained through the curing period to form the flavor cheese product.

2. The method of claim 1, wherein the curing period is about 1 to 6 weeks, such as about 3 to 4 weeks.

3. The method of claim 1, wherein an acid degree value (ADV) of the flavor cheese product is least 8.

4. The method of claim 1, wherein the flavor cheese product contains at least about 2.0 wt % non-protein nitrogen (NPN).

5. The method of claim 1, further comprising adding rennet during the adding of the lipase, the protease or both.

6. The method of claim 5, wherein the lipase is added to the transferred fermented adjusted milk composition, said lipase added separately from the added rennet, and separately from the protease, when present.

7. The method of claim 1, wherein the adjusted milk composition is a microfiltration concentrate having the reduced protein-to-fat ratio.

8. The method of claim 1, wherein the adjusted milk composition is an ultrafiltration concentrate having the reduced protein-to-fat ratio.

9. The method of claim 1, wherein the adjusted milk composition is fermented by a cheese culture.

10. The method of claim 1, wherein the adjusted milk composition is maintained at a temperature below about 98 °F during the fermenting and the transferring.

11. The method of claim 1, wherein the cheese composition includes about 60 to about 70 wt % solids.

12. The method of claim 1, further comprising heating the adjusted milk composition prior to transferring to at least 165 °F.

13. The method of claim 1, further comprising holding the cured cheese product at refrigeration temperatures.

14. The method of claim 1, wherein prior to fermenting, the adjusted milk composition is heat treated to a temperature of about 155 °F to about 175 °F and then cooled to a temperature of about 110 °F or about 86 °F.

15. A fermented flavor cheese product comprising an admixture of a cured enzyme-modified fermentation base, one or more active dairy cultures, one or more active lipases, active proteases or both, and a total solids content of at least 60 wt %, the one or more active lipases, proteases or both retained in the fermented flavor cheese product, the fermented flavor cheese product having been fermented without rennet and having been cured for about 3 to 6 weeks.

16. The fermented flavor cheese product of claim 15, wherein the one or more active dairy cultures are retained in the fermented flavor cheese product.

17. The fermented flavor cheese product of claim 15, wherein a fat content is about 30 wt % to about 33 wt % of the product, and protein is about 18 wt % to about 22 wt % of the product.

18. The fermented flavor cheese product of claim 15, wherein an acid degree value (ADV) of the product is least 10, the product contains at least about 2.0 wt % non-protein nitrogen (NPN), or both.

19. A system for producing a flavor cheese product, the system comprising:
a fermenter for causing in situ production of lactic acid in an adjusted milk composition to produce a fermentation base, wherein the fermentation base is free of rennet;
at least one pump arranged downstream of the fermenter, each of the at least one pump for pumping a lipase or a protease into the fermentation base after exiting the fermenter;
an evaporator arranged downstream of the fermenter for evaporating at least a portion of water from therefrom at a temperature of about 80 °F up to about 120 °F to form a cheese composition; and
a curing environment for curing the cheese composition for a curing period of about 3 to 6 weeks at a temperature between about 38 °F to about 75 °F,
wherein enzymatic activity of the lipase, the protease or both is maintained through the curing period to form the flavor cheese product.

20. The system of claim 19, further comprising a balance tank arranged downstream of the fermenter and upstream of the evaporator, wherein the balance tank receives the pumped lipase, the protease or both and the fermentation base.
